(19) United States
(12) Patent Application Publication
(10) Pub. No.: US 2025/0214654 A1
(43) Pub. Date: Jul. 3, 2025

(54) Side Sill for a Motor Vehicle Body

(71) Applicant: Bayerische Motoren Werke Aktiengesellschaft, Muenchen (DE)

(72) Inventors: Uwe FUNKE, Haimhausen (DE); Nermin KECALEVIC, Markt Schwaben (DE)

(21) Appl. No.: 18/851,757

(22) PCT Filed: May 2, 2023
(86) PCT No.: PCT/EP2023/061534

§ 371 Date: Sep. 27, 2024

(30) Foreign Application Priority Data
May 27, 2022 (DE) 10 2022 113 406.7

(51) Int. Cl. B62D 25/02

(52) U.S. Cl. CPC B62D 25/025

(57) ABSTRACT

A side sill for a motor vehicle body is composed of multiple sill parts that delimit a cavity in which a profiled reinforcing section is arranged. The profiled reinforcing section is designed as a multi-chamber profiled section and has an inner face that is supported against an inner sill part. In order to support the inner face of the profiled reinforcing section against the inner sill part of the side sill, the profiled reinforcing section has a support base on the inner face, the support base protruding downwards from a main part in the vehicle vertical direction.

### BACKGROUND AND SUMMARY

The invention relates to a side sill for a motor vehicle body that is composed of multiple sill parts, which bound a cavity, containing a reinforcement profile, which is in the form of a multi-chamber profile and is supported by way of an inner side against an inner sill part.

Such a side sill is already known, for example, from Tesla Model 3. The side sill in this case is composed of multiple sill parts, which bound a cavity containing a reinforcement profile in the form of a multi-chamber profile. This multi-chamber profile, or reinforcement profile, is supported by way of an inner side against an inner sill part of the side sill.

The reinforcement profile allows for the increased need for safety in purely electric motor vehicles, which, in particular in the event of a side impact, simulated for example by a pole impact test, require greater safety against excessive damage to the underfloor energy store. In particular, the specific intention is to use the respective reinforcement profiles, which are integrated in the side sills, in the event of a pole impact to provide a structure which prevents excessive damage and intrusion into the energy store housing and thus concomitantly prevents the battery cells inside the energy store housing from being subjected to considerable loading.

Specifically in the event of a pole impact, however, there is the problem that, for an optimally functioning crash concept, the reinforcement profile in the form of a multi-chamber profile should not tilt out of the force direction, in particular owing to an obliquely acting introduction of torque, as it deforms and absorbs energy, such that the reinforcement profile cannot be exploited to its full potential as regards the deformation and energy absorption.

An object of the present invention is therefore to provide a side sill of the type mentioned at the outset and in the case of which it is possible to easily ensure that the reinforcement profile can exploit its optimum deformation and energy absorption capabilities in the event of an application of force caused by an accident.

This object is achieved according to the invention by a side sill having the features of the independent claims(s). The dependent claims relate to advantageous configurations containing expedient refinements of the invention.

The side sill according to the invention for a motor vehicle body is composed of multiple sill parts which delimit a cavity containing a reinforcement profile in the form of a multi-chamber profile. In order to achieve particularly favorable support of the reinforcement profile by way of its inner side against an inner sill part of the side sill, the reinforcement profile on the inner side has a supporting base protruding downward in the vehicle vertical direction from a main part. This supporting base ensures in particular that, in the event of an application of force caused by an accident, in particular owing to a side impact, and further in particular in the event of a pole impact, the reinforcement profile is reliably supported against the inner sill part, with the result that even in the event of an oblique introduction of forces and a corresponding introduction of torque, the reinforcement profile for example cannot tilt away downward.

Rather, the effect of the supporting base is improved support of the reinforcement profile against the inner sill part, with the result that the reinforcement profile, or in particular its main part, cannot move, or tilt, out of the main force direction, which acts in the vehicle transverse direction and horizontally from outside to inside. The effect of this is that the optimum potential of the reinforcement part as regards the deformation and energy absorption capabilities in the event of a side impact, in particular a pole impact, can be exploited. In this case, the supporting base can be used to compensate for any torque that might arise on the reinforcement profile with a counter-torque generated in the region of the supporting base.

In a further configuration of the invention, it has been found to be advantageous if a guide profile, along which the reinforcement profile can be pushed into the cavity by way of an end face of the side sill, is arranged on the inner sill part. This makes it possible to easily mount the reinforcement profile inside the corresponding cavity of the side sill. Consequently, use can be made for example of an existing structure of the motor vehicle body.

It has also been found to be advantageous if the reinforcement profile can be pushed into the guide profile by way of the supporting base. The supporting base can, accordingly, easily perform a dual function, i.e. on the one hand achieve improved support of the reinforcement profile on the inner sill part and on the other hand improve the insertion of the reinforcement profile into the corresponding cavity of the side sill.

A further advantageous embodiment provides that the guide profile has a substantially S-shaped cross section with a first limb, which fastens the guide profile to the inner sill part, and with an intermediate limb and a second limb, which guide and retain the supporting base of the reinforcement profile. This results in easy guidance of the supporting base of the reinforcement profile inside the cavity of the side sill.

A further advantageous embodiment of the invention provides that the guide profile at least substantially forms a form fit with the supporting base of the reinforcement profile. The effect of this is particularly stable and rigid retention of the reinforcement profile on the guide profile.

A further advantageous embodiment provides that the supporting base is in the form of a supporting wall. Such a supporting base can be produced particularly easily and can thereby be easily designed to interact with the guide profile.

As an alternative to this, however, it is also possible that the supporting base is in the form of a chamber profile or the like. Such a chamber profile ensures a particularly rigid supporting base, which moreover can be guided possibly also along a guide profile.

In a further configuration of the invention, the reinforcement profile is connected to the inner sill part via a joining connection and/or mechanical connectors. The effect of this is, as an alternative or in addition to the already described form fit between the guide profile and the supporting base, a particularly rigid and stable attachment of the reinforcement profile to the inner sill part.

Lastly, it has been found to be advantageous if the reinforcement profile in the region of the main part is connected to the inner sill part. This establishes a particularly stable support in the line of force acting on the reinforcement profile.

Further features of the invention emerge from the claims, the figures and the description of the figures. The features and combinations of features cited above in the description and the features and combinations of features cited below in the description of the figures and/or shown in the figures alone can be used not only in the respective specified combination but also in other combinations or on their own.

The invention will now be explained in more detail on the basis of two preferred exemplary embodiments and with reference to the drawings.

### BRIEF DESCRIPTION OF THE DRAWINGS

FIG. 1 is a perspective sectional view through a detail of a side sill according to an embodiment of the invention for a motor vehicle body, comprising a reinforcement profile which is inserted in a cavity of the side sill, is in the form of a multi-chamber profile, and is supported by way of an inner side against an inner sill part, wherein the reinforcement profile on its inner side has a supporting base which protrudes downward in the vehicle vertical direction from a main part and by which the reinforcement profile can be pushed into a guide profile, which retains the reinforcement profile on the inner sill part in a form fit.

FIG. 2 is a sectional view of a detail of the side sill comprising the reinforcement profile according to FIG. 1 retained on the guide profile,

FIG. 3 is a further perspective sectional view of a detail of a side sill comprising a reinforcement profile which is integrated in its cavity, also is in the form of a multi-chamber profile, and has a downwardly protruding supporting base which is also in the form of a chamber profile.

FIG. 4 is a sectional view of a detail of the side sill according to FIG. 3.

### DETAILED DESCRIPTION OF THE DRAWINGS

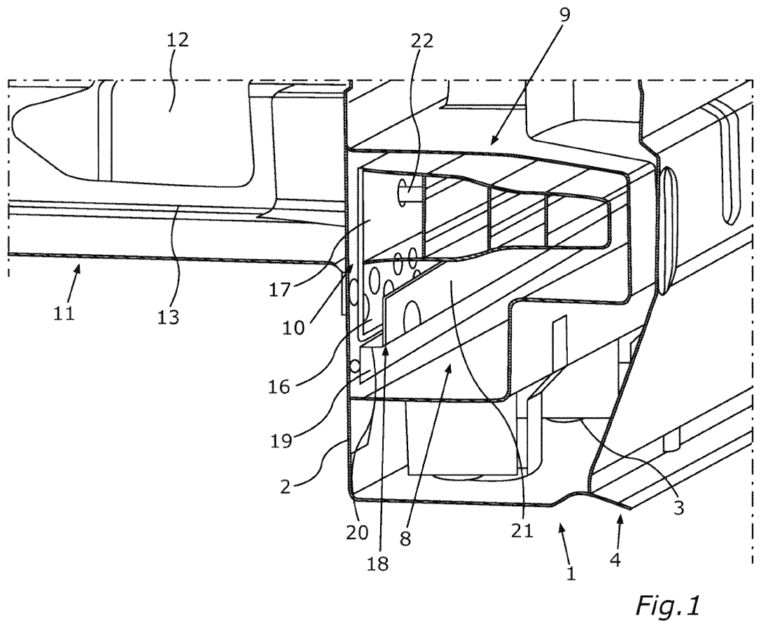

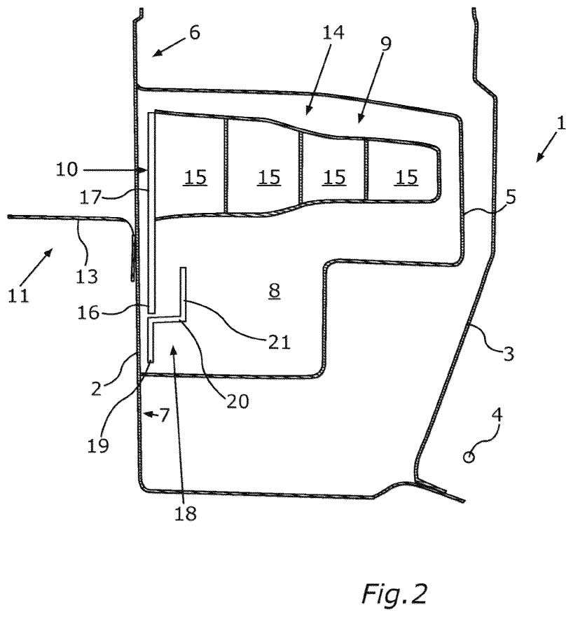

FIG. 1 shows a perspective sectional view of a detail of a side sill 1 for a motor vehicle body. As is evident when considered together with FIG. 2, which shows a sectional view of the side sill 1, in the present case the side sill 1 is composed of multiple sill parts, for example with a sheet-metal tray structure. What is evident here is an inner sill part 2 and an outer sill part 3, which are connected to one another in the region of a flange connection 4 at the outer end, as viewed in the vehicle transverse direction, or lower end, as viewed in the vehicle vertical direction. The side sill 1 moreover comprises a stiffening part 5, which is connected to the inner sill part 2 in the region of respective flange connections 6, 7.

The reinforcement part 5 and the inner sill part 2 form a cavity 8 of the side sill 1, which contains a reinforcement profile 9 supported by way of an inner side 10 against the inner sill part 2. The reinforcement part 5 and the inner sill part 2 delimit the cavity 8 for example over the entire length of the side sill 1, with the reinforcement profile 9 also extending for example over at least approximately the entire length of the side sill 1.

A floor structure 11 of the motor vehicle body adjoins the inner side of the inner sill part 2 and comprises for example respective crossmembers 12 (FIG. 1) and parts 13 of the floor panel.

As is evident from considering FIGS. 1 and 2 together, the reinforcement profile 9 in a main part 14 has a multi-chamber profile having in the present case, for example, four hollow chambers 15. This multi-chamber profile is produced for example by extrusion, hollow profiling or the like of the entire reinforcement profile 9. On the inner side 10, the reinforcement profile 9 starting from the main part 14 has a supporting base 16 protruding downward in the vehicle vertical direction. In the present case, this supporting base 16 is in the form of a simple extension of a wall 17, which delimits the main part 14, or the corresponding hollow chamber 15, on the inner side 10. The supporting base 16 is formed in one piece with the main part 14 of the reinforcement profile 9. The wall 17 with the supporting base 16 for example is flat and extends perpendicularly in the vehicle vertical direction and in the vehicle longitudinal direction. The wall 17, or the supporting base 16, supports the reinforcement profile 9 against the inner sill part 2.

The cavity 8 moreover contains a guide profile 18, which is arranged on and fastened to the inner sill part 2 by means of a first limb 19, for example via a joining connection, in particular a spot-welded connection or the like. In this respect, the guide profile 18 has a substantially S-shaped cross section and comprises, in addition to the first limb 19, an intermediate limb 20, which extends in the vehicle longitudinal direction and in the vehicle transverse direction and via which the first limb 19 is formed in one piece with a second limb extending in the vehicle longitudinal direction and in the vehicle height direction.

The connecting limb 20 and the second limb 21 serve as a guide, by means of which the reinforcement profile 9 can be pushed for example by way of a front side or a rear side of the side sill 1 into its cavity 8. In the process, the guide, formed by the connecting limb 20 and the second limb 21, of the guide profile 18 interacts with the downwardly protruding supporting base 16 of the reinforcement profile 9.

Accordingly, in particular the second limb 21 is spaced from the inner sill part 2 for example at such a spacing and in parallel fashion that it is possible to push the reinforcement profile 9 into the cavity 8 of the side sill 1. Similarly, however, the guide profile 18 is at least substantially also to establish a form fit with the supporting base 16 of the reinforcement profile 9, with the result that it is retained and supported on the inner sill part 2 particularly favorably.

As FIG. 1 shows, the reinforcement profile 9 is moreover connected to the inner sill part 2 via mechanical connectors 22, for example screws, rivets or the like. These connectors 22 can be applied as soon as the reinforcement profile 9 by way of its end is pushed in the cavity 8, or the guide profile 18, and positioned.

In addition or as an alternative to the mechanical connectors 22, other connections, for example joining connections, would also be contemplated. The mechanical connectors 22 may be arranged in particular in the region of the main part 14 of the reinforcement profile 9. Moreover, the connectors 22 may also be arranged in the region of the supporting base 16.

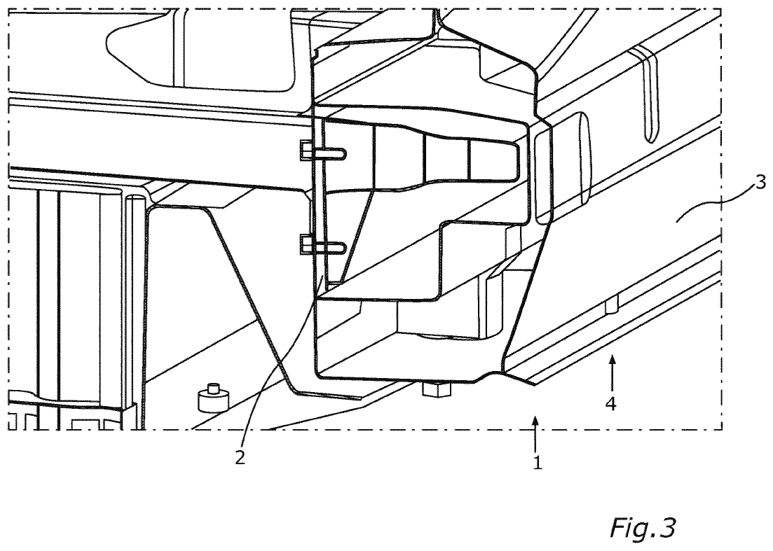

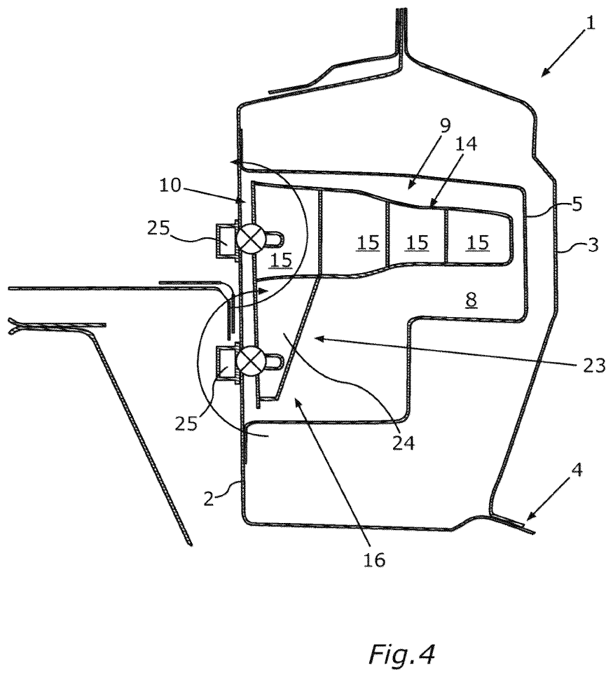

FIGS. 3 and 4 show a perspective sectional view of a detail and a further sectional view, respectively, of a second embodiment of the side sill 1, which substantially differs from the first embodiment according to FIGS. 1 and 2 by the configuration of the local reinforcement profile 9 and its fastening to the inner sill part 2. Accordingly, only the differences between the two embodiments will be discussed below; in all other respects, it should be assumed that the configuration of the side sill 1 is identical.

By contrast to the embodiment according to FIGS. 1 and 2, in the present case what is provided is a supporting base 16 which is not in the form of a simple wall 17, but rather of a chamber profile 23 delimiting a further hollow chamber 24. The chamber profile 23 and the chamber profile of the main part 14 are formed in one piece in this case.

In the present exemplary embodiment, besides, no guide profile 18 for pushing the reinforcement profile 9 in is provided, but rather the reinforcement profile is pushed, or inserted, in the cavity and connected to the inner sill part 2 by means of respective connectors, for example in the form of screws, both in the region of the main part 14 and in the region of the supporting base 16. As an alternative or in addition, it is additionally also possible to use other connecting means or joining connections or the like here.

FIG. 4 here again depicts the functioning of the supporting base 16. An introduction of torque M can occur at the inner end of the main part 14 of the reinforcement profile 9 when a corresponding force is applied to the side sill 1 and thus concomitantly the reinforcement profile 9 in the event of a side impact, this force not acting directly horizontally and in the vehicle transverse direction on the support point of the reinforcement profile 9 on the inner sill part 2. Such an oblique force, with a direction of action for example in the vehicle transverse direction from the outside at the bottom to the inside at the top, may for example arise in the event of a pole impact of the motor vehicle in the region of the corresponding side sill 1.

In order to generate a corresponding counter-torque MG in this case, the respective supporting base 16 is provided, which has the effect that the reinforcement profile 9, or the main part 14, cannot tilt for example counterclockwise out of the line of force, but rather can be used for energy absorption over at least approximately the full deformation length. Depending on the introduction of force, the supporting base may either support compressive forces between it and the inner sill part 2 or—as shown in FIG. 4—react corresponding tensile forces between the inner sill part 2 and the reinforcement profile 9.

### LIST OF REFERENCE SIGNS

1 Side sill
2 Sill part
3 Sill part
4 Flange connection
8 Stiffening part
6 Flange connection
7 Flange connection
8 Cavity
9 Reinforcement profile
10 Inner side
11 Floor structure
12 Crossmember
13 Parts
14 Main part
15 Hollow chamber
16 Supporting base
17 Wall
18 Guide profile
19 Limb
20 Connecting limb
21 Limb
22 Connectors
23 Chamber profile
24 Hollow chamber
25 Connectors

1.-9. (canceled)

10. A side sill for a motor vehicle body, comprising:
multiple sill parts which delimit a cavity;
a reinforcement profile contained in the cavity, the reinforcement profile having a main part with a multi-chamber profile and being supported by way of an inner side against an inner sill part of the multiple sill parts,
wherein the reinforcement profile, on an inner side, has a supporting base protruding downward in a vehicle vertical direction from the main part of the reinforcement profile.

11. The side sill according to claim 10, further comprising:
a guide profile, along which the reinforcement profile is insertable into the cavity from an end face of the side sill, wherein
the guide profile is arranged on the inner sill part.

12. The side sill according to claim 11, wherein
the reinforcement profile is pushed into the guide profile by way of the supporting base of the reinforcement profile.

13. The side sill according to claim 12, wherein
the guide profile has a substantially S-shaped cross section with a first limb, which fastens the guide profile to the inner sill part, and with an intermediate limb and a second limb, which guide and retain the supporting base of the reinforcement profile.

14. The side sill according to claim 12, wherein
the guide profile at least substantially forms a form fit with the supporting base of the reinforcement profile.

15. The side sill according to claim 10, wherein
the supporting base is in the form of a supporting wall.

16. The side sill according to claim 10, wherein
the supporting base is in the form of a chamber profile.

17. The side sill according to claim 10, wherein
the reinforcement profile is connected to the inner sill part via a joining connection and/or mechanical connectors.

18. The side sill according to claim 17, wherein
the reinforcement profile is connected to the inner sill part in a region of the main part of the reinforcement profile.
